(19) United States
(12) Patent Application Publication
(10) Pub. No.: US 2026/0110939 A1
(43) Pub. Date: Apr. 23, 2026

(54) METHOD FOR PREPARING A LENTICULAR DEVICE FOR A 2D / 3D SWITCHABLE AUTOSTEREOSCOPIC DISPLAY

(71) Applicant: Dimenco Holding B.V., Veldhoven (NL)

(72) Inventors: Patrick Godefridus Jacobus Maria Peeters, Veldhoven (NL); Levgen Kurylo, Veldhoven (NL); Hubertus Petrus Cornelis van Kuringen, Veldhoven (NL); Bas Koen Böggemann, Veldhoven (NL)

(21) Appl. No.: 19/134,451

(22) PCT Filed: Dec. 1, 2023
(86) PCT No.: PCT/NL2023/050628

§ 371 Date: May 30, 2025

(30) Foreign Application Priority Data
Dec. 1, 2022 (NL) 2033653

(51) Int. Cl. G02F 1/1345; B29D 11/00; G02B 3/00; G02B 30/28; G02F 1/13; G02F 1/1335; G02F 1/1339

(52) U.S. Cl. CPC G02F 1/1345; B29D 11/00298; B29D 11/0048; B29D 11/00807; G02B 3/0031; G02B 30/28; G02F 1/1313; G02F 1/133526; G02F 1/13398

(57) ABSTRACT

The invention relates to a method for preparing a lenticular lens on a conductive surface of a transparent support, the method comprising imprinting a curable resin on the support with a lenticular mold, followed by curing the resin and removing the mold to yield a lenticular device comprising the transparent support and a lenticular lens provided thereon. A small part of the curable resin comprises conductive particles, which after curing provide the lenticular lens with a conductive path between the conductive support surface and the lenticular lens surface. The conductive support surface is in this way easily and directly electrically accessible as a planar electrode, when the lenticular device is incorporated in an electrically switchable liquid crystal cell. Accordingly, the invention further relates to such lenticular device, to a liquid crystal cell comprising such lenticular device, and to an autostereoscopic display device comprising such liquid crystal cell.

### FIELD OF THE INVENTION

The invention relates to a method for preparing a lenticular lens on a conductive surface of a transparent support and for preparing a liquid crystal cell comprising such lenticular lens.

The invention further relates to a lenticular device comprising a lenticular lens, to a liquid crystal cell comprising such lenticular device, and to an autostereoscopic display device comprising such liquid crystal cell.

### BACKGROUND

Autostereoscopic displays with a lenticular lens allow a viewer to perceive three-dimensional images without a dedicated eyewear device such as glasses or a headset. These displays are playing an increasingly important role in virtual reality and augmented reality applications.

A lenticular lens is composed of semi-cylindrical micro-lenses (lenticulars) that are arranged parallel to one another. In an autostereoscopic display, the lenticular lens is provided over an array of (sub-)pixels, each lenticular being associated with a particular arrangement of (sub-)pixels. By properly controlling these (sub)-pixels, the autostereoscopic display is capable of simultaneously directing a left eye image to a left eye of the viewer and a right eye image to a right eye of the viewer. The resulting stereoscopic image provides a depth perception wherein elements in the image may appear in front of the display or further away than the display (‘behind’ the display).

A special type of autostereoscopic display is a so-called “2D/3D switchable autostereoscopic display”. Such display is capable of electrically switching between a two-dimensional view mode and a three-dimensional view mode. It relies on a liquid crystal cell wherein the lenticular lens is adjacent to a liquid crystal medium that can switch between two liquid crystal orientations under the influence of an electrical field. In the 2D view mode, the liquid crystal medium is in a first orientation. Its refractive index matches that of the lenticulars, thereby depriving the lenticulars from a focusing effect and causing the lenticular lens to behave as a transparent and flat optical panel. In the 3D view mode, the liquid crystal medium is in a second liquid crystal orientation. The refractive indices do not match, which allows each lenticular to exhibit a focusing effect.

The electrical switching between the 2D and 3D view modes occurs by applying a switching voltage across two planar switching electrodes that sandwich the liquid crystal cell. One of the electrodes is lined with the lenticular lens, opposite to the side that harbors the lenticulars. The other electrode is on the opposite side of to the liquid crystal cell. Both electrodes need to be electrically accessible for the manufacture of a working 2D/3D switchable autostereoscopic display with a liquid crystal cell.

The lenticular lens itself is commonly manufactured by stamping a lenticular profile on an (uncured) curable resin solution that is present as a continuous film on a planar electrode, followed by curing the curable resin. Such electrode is a conductive surface on an otherwise electrically insulating support.

Already at this stage, the electrical accessibility of the electrode needs to be taken care of, because the electrode becomes completely enclosed by the support and the curable resin upon providing and curing the curable resin on the support.

The problem with current manufacturing methods, however, is that stamping a profile on a curable resin solution does not allow to keep some electrode areas uncovered with resin, even when a highly protruding part of the stamp (a so-called ‘dam’) is pressed onto the electrode surface. A thin layer of cured resin always forms between the electrode and the dam. Such layer is thick enough to isolate the electrode, making it difficult to make an electrical connection to the electrode.

This is conventionally solved by e.g. removing cured resin from certain desired areas of the conductive surface (i.e. of the electrode), so as to lay bare some surface areas of the electrode and make them available for an electrical connection; or by removing uncured resin from an area that has been shielded from curing by a mask. These are however undesired procedures, as they require an extra processing step and generate waste, such as removed cured resin and, in case resin is removed by dissolving it in a solvent, solvent. In addition, removal of resin by burning it with a laser has also proven unsuccessful, as this causes for example damage to the conductive surface.

Alternatively, the lens is 3D-printed directly with the desired lens shape, leaving some areas free of lens material. 3D-printing of a lenticular lens is however not feasible on an industrial scale.

To date, no satisfactory solution to make the planar electrode electrically accessible has been proposed.

### SUMMARY OF THE INVENTION

It is therefore an object of the present invention to provide a lenticular lens on a planar electrode wherein the planar electrode is easily and/or directly electrically accessible. It is more generally an object to provide an improved liquid crystal cell for a 2D/3D switchable autostereoscopic display device, in particular to provide a lenticular device for a 2D/3D switchable autostereoscopic display device that has an improved capability to be electrically connected to other electrical devices or components.

It is also an object of the present invention to provide a method for covering a planar electrode with a lenticular lens to yield a planar electrode that is easily and/or directly electrically accessible, wherein the lenticular lens is formed by curing a curable resin. It is more generally an object of the present invention to provide an improved method of manufacturing a 2D/3D switchable autostereoscopic display device, in particular to provide an improved method of manufacturing a liquid crystal cell for such device.

It has now been found that one or more of these objects can be reached by a particular way of making the lenticular lens material locally conductive.

Accordingly, the present invention relates to a method for preparing a lenticular lens on a conductive surface of a transparent support, the method comprising
providing a layer of a curable resin on the conductive surface of the transparent support;
providing a mold comprising a lenticular surface representing the lenticular lens in negative relief;
contacting the lenticular surface of the mold with the layer of curable resin;
curing the curable resin to form a layer of a transparent cured resin;
releasing the mold to yield the lenticular lens on the transparent support, the lenticular lens having a shaped surface that has been shaped by the mold, the shaped surface comprising lenticular elements;
wherein
a part of the layer of curable resin comprises first conductive particles, which after curing provide the lenticular lens with a conductive path between the conductive surface of the support and the shaped surface of the lenticular lens.

The invention further relates to a lenticular device (1), comprising
a support (2) comprising a conductive surface (3) capable of acting as a first electrode;
a layer of a transparent cured resin (4b) provided on the conductive surface (3) of the support (2), the transparent cured resin (4b) forming a lenticular lens having a shaped surface (5) comprising lenticular elements;
wherein
a part of the layer of transparent cured resin (4b) comprises first conductive particles (6), which provide the lenticular lens with a conductive path (7) between the conductive surface (3) of the support and the shaped surface (5) of the lenticular lens.

The invention further relates to a liquid crystal cell (10) comprising a cavity that is filled with a liquid crystal medium (16), the cavity being defined by at least
a lenticular device (1) as described hereabove;
a transparent plate (11) that is provided over the lenticular lens of the lenticular device (1) so that the transparent plate (11) faces the shaped surface (5) of the lenticular lens, the transparent plate (11) comprising a conductive layer (13) capable of acting as a second electrode;
a sealing (12) that connects the lenticular device (1) and the transparent plate (11).

The invention further relates to an autostereoscopic display device comprising a lenticular device (1) and/or a liquid crystal cell (10) as described hereabove.

### BRIEF DESCRIPTION OF THE DRAWINGS

FIG. 1 schematically displays the steps of a conventional method for preparing a lenticular lens on a transparent support.

FIG. 2 schematically displays the steps of a method of the invention for preparing a lenticular lens on a transparent support.

FIG. 3 schematically displays a cross-sectional view of a magnified part of a conventional lenticular device obtained with the method illustrated in FIG. 1.

FIG. 4 schematically displays a cross-sectional view of a magnified part of a lenticular device (1) according to the invention, obtained with the method illustrated in FIG. 2.

FIG. 5 schematically displays a cross-sectional view of a first liquid crystal cell (10) according to the invention.

FIG. 6 schematically displays a cross-sectional view of a second liquid crystal cell (10) according to the invention.

FIG. 7 schematically displays a cross-sectional view of a magnified part of the first liquid crystal cell (10) as displayed in FIG. 5.

FIG. 8 schematically displays a cross-sectional view of a magnified part of the second liquid crystal (10) cell as displayed in FIG. 6.

### DETAILED DESCRIPTION OF THE INVENTION

The figures do not limit the present invention to the specific embodiments disclosed therein and described in the present description. Elements in the figures are illustrated for simplicity and clarity and have not necessarily been drawn to scale, emphasis instead being placed upon clearly illustrating the principles of the invention. For example, the (relative) dimensions of lenticular elements, conductive particles and conductive paths cannot be derived from the figures. The shape and appearance of a liquid crystal cell in the figures is not intended to be a reflection of reality. Its dimensions relative to the dimensions of e.g. electrode spacing and lenticular elements can neither be derived from the figures.

A lenticular lens is a lens that is composed of semi-cylindrical micro-lenses (lenticulars) that are arranged parallel to one another. Herein, the term ‘arranged’ is merely used to describe a certain look or appearance rather than a composition of separate parts, since the lenticular elements are not arranged as separate objects. A lenticular lens in accordance with the invention in principle consists of one single part, wherein the different lenticular elements are all part of the same piece of material.

In the present application, objects and elements are described that have the property of being “electrically conductive”. For the sake of clarity and conciseness, this property is in some cases indicated solely with the term “conductive”. Analogously, the term “electrical conductivity” is in some cases reduced to “conductivity”. In cases where a conductivity other than an electrical conductivity is meant, if any, this will be explicitly specified.

Further, the terms “first”, “second”, and the like in the present description and claims, if any, are generally used for distinguishing between similar elements or items and not necessarily for describing a sequential or chronological order.

According to conventional methods and according to the invention, the lenticular lens is prepared by fixating a lenticular surface of a lens material on a conductive surface of a transparent support. This is performed by imprinting a lenticular surface of a mold on a layer of a curable resin, followed by curing the curable resin to thereby fixate the lenticular surface and adhere the lenticular lens to the support. The lenticular lens itself is then basically made from the cured resin. After the curing, the mold is released from the cured resin to yield the lenticular lens on the transparent support. For the purpose of the invention, this composition of a support and a lenticular lens is termed ‘lenticular device’.

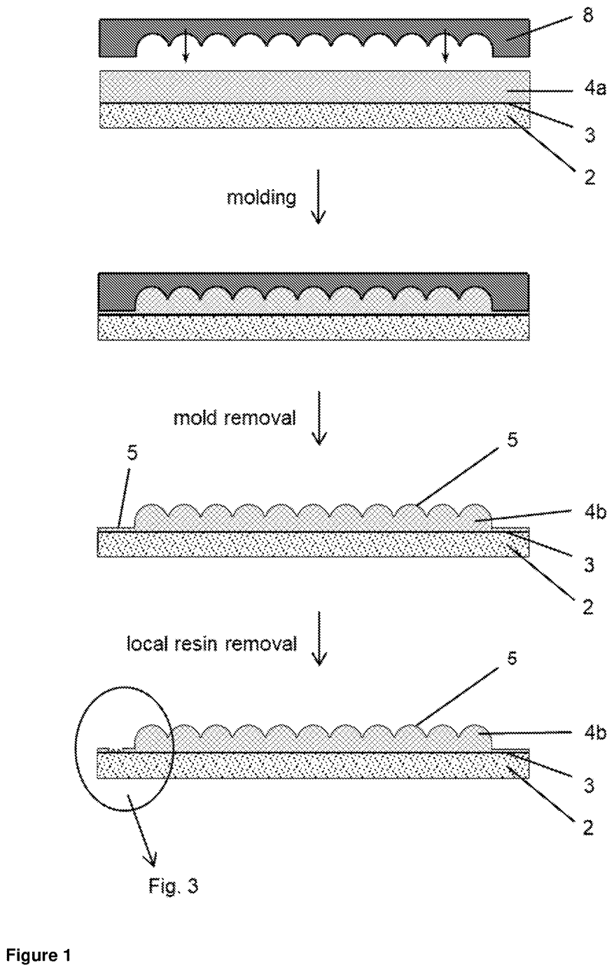

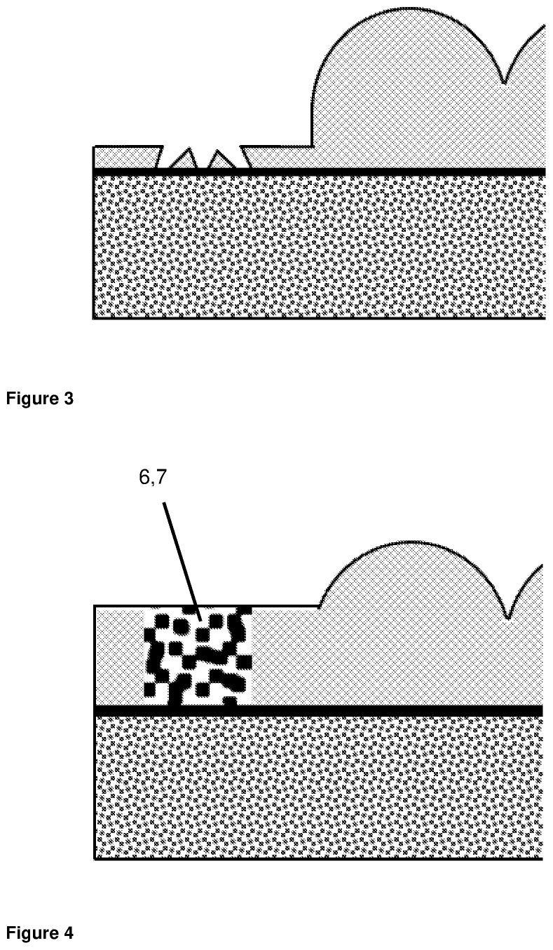

In the prior art, as a final step, the conductive surface is made available for an electrical connection to an external electronic device (e.g. a power source). This is for example performed by removing cured resin so as to lay bare an underlying surface area of the conductive surface. This is for example performed by abrasion, laser ablation or plasma ablation. Such conventional process is illustrated in FIG. 1. An enlargement of the area where the cured resin has been removed is displayed in FIG. 3. Alternatively, conventional removal may concern washing away uncured resin that has been shielded by a mask during curing.

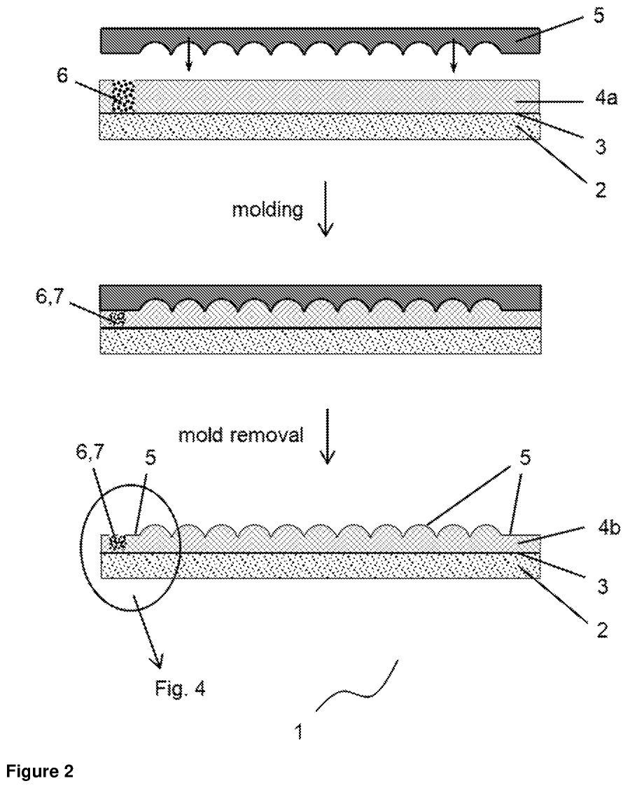

According to the invention, however, a conductive path is formed in the cured resin which avoids the conventional step of removing cured or uncured resin. This process according to the invention is illustrated in FIG. 2. An enlargement of the area where the conductive path has been introduced is displayed in FIG. 4. The method of the invention will be further explained below.

The support in a method of the invention is a transparent material, i.e. it is transparent to at least the wavelengths of visible light (e.g. 380-750 nm). The support comprises a main support material that is transparent, such as a glass. It has a conductive surface, typically a surface that is formed by a conductive layer present on the main support material. The conductive surface is in fact a planar electrode and may function as such when connected to a voltage source. When the conductive surface of the support is hereafter referred to as an electrode, then it will be termed ‘first electrode’.

A conductive layer that forms such conductive surface is typically a thin layer of an electrically conductive material, having a thickness in the range of e.g. 20-100 nm. The electrically conductive material usually comprises a transparent conductive metal oxide wherein the metal comprises one or more elements selected from the group of chromium, tin, aluminum, zinc, copper and nickel. Preferably it is indium tin oxide. It may also be a tin oxide or a zinc oxide doped with aluminum or gallium. The conductive surface may also be a fine grid of conductive wires, such as silver wires.

In a method of the invention, the curable resin is provided directly on the conductive surface of the support so that the conductive surface comes in contact with the curable resin (and afterwards with the cured resin). This is for example performed by spraying (e.g. airbrush) or printing.

The mold comprises a lenticular surface that represents the lenticular lens in negative shape, so that curable resin adjacent to the mold takes over the shape of the mold, yet in opposite relief.

The curable resin is typically a deformable substance such as a fluid or a gel. It is deformable due to contacting it with the mold, in accordance with a method of the invention. The curable resin is cured by means of e.g. heat or UV-radiation, to yield a transparent cured resin, being transparent to at least the wavelengths of visible light (e.g. 380-750 nm). For example, it comprises an epoxy resin (a heat-curable resin) or an acrylate resin (a UV-curable resin).

In a method of the invention, a part of the layer of curable resin is provided with particular conductive particles (from here on referred to as ‘first conductive particles’). When the curable resin is (or has been) cured, these first conductive particles form an electrically conductive region in the cured resin, hereinafter referred to as the ‘conductive path’. This conductive path is present between the conductive surface of the support and the shaped surface of the lenticular lens. It is actually an equivalent of a conventional wire that is connected to the electrode, making the conductive surface of the support electrically accessible for e.g. a power source via the shaped surface of the lenticular lens (i.e. an electrical connection with the conductive path can be made by connecting with the corresponding area of the shaped surface of the lenticular lens).

The first conductive particles are usually locally dispersed in a particular region of the layer of curable resin where the electric conductivity is desired—usually outside the functional optical area. This is for example performed by applying the pure resin with a first nozzle and a mixture of the resin and first conductive particles with a second nozzle—each nozzle applying its feed on a desired area of the conductive surface of the support. It is however not necessary to pre-mix the particles with the resin. The particles may also be first applied as such at the desired areas, followed by applying the resin over the entire conductive surface, including the area where the particles are disposed. Their presence is preferably compatible with the molding step (imprinting), not disrupting the correct imprinting of the lenticular shapes.

The electrical conductivity of the conductive path may be due to the particles' close proximity or even mutual contact, when the particle dimensions (in particular the largest dimension of the particles) are smaller than the thickness of the part of the finally obtained layer of cured resin that comprises the first conductive particles. To achieve this upon curing, the particles are dispersed in the particular part of the curable resin in an appropriate manner. The particle size may also exceed the thickness of the finally obtained layer of cured resin. In such case, the smallest dimension of the first conductive particles is larger than the thickness of the part of the finally obtained layer of cured resin that comprises the first conductive particles.

The first conductive particles are electrically conductive. They have a capability to act as a conductive element when positioned adjacent to one another. Therefore, the first conductive particles are at least at their outside electrically conductive. They may be made of a particular conductive material, preferably of a metal or a mixture of metals. They are for example made of a metal selected from the group of nickel, copper, palladium, silver, platinum and gold. They may also have a metallic outer surface that surrounds an inner material that is not conductive, such as a non-conductive polymer (e.g. an acrylate). Preferably, the inner material is flexible so that the particles deform when pressed together. This property allows that the particles have a greater contact surface with one another when pressed together. Such particles are known in the art. Their metallic outer surface may be made of one or more metals selected from the group of nickel, copper, palladium, silver, platinum and gold.

The lenticular device may be subject to further processing steps, such as steps in the manufacturing of a liquid crystal cell, a switchable liquid crystal cell wherein liquid crystal orientation can be controlled or a 2D/3D switchable autostereoscopic display device.

For the manufacture of a liquid crystal cell, the method of the invention is typically followed by the steps of
providing a transparent plate over the lenticular lens so that the transparent plate faces the shaped surface of the lenticular lens; then
providing a sealing material between the lenticular lens and the transparent plate to form a cavity defined by the lenticular lens, the transparent plate and the sealing material;
allowing the sealing material to form a sealing that adheres to both the lenticular lens and the transparent plate; then
filling the cavity with a liquid crystal medium to yield the liquid crystal cell; or by the steps of
applying a liquid crystal medium on the shaped surface of the lenticular lens;
applying a sealing material on a circumference of the shaped surface of the lenticular lens; thereafter
providing a transparent plate over the lenticular lens so that the transparent plate faces the shaped surface of the lenticular lens and touches the sealing material and the liquid crystal medium;
allowing the sealing material to form a sealing that adheres to both the lenticular lens and the transparent plate, to thereby yield the liquid crystal cell, the liquid crystal medium being present in a cavity of the liquid crystal cell, which cavity is defined by the lenticular lens, the transparent plate and the sealing material.

The liquid crystal medium is thus sandwiched between the shaped surface of the lenticular lens and the transparent plate. The sealing is typically present along borders of the lenticular lens and is usually also sandwiched between the shaped surface of the lenticular lens and the transparent plate.

In a preferred embodiment, the transparent plate comprises a conductive layer. This conductive layer and the conductive surface of the support then form two planar switching electrodes that sandwich the liquid crystal medium and allow switching between two orientations of the liquid crystal. To actually make a working switchable liquid crystal cell, both electrodes need to be connected to a (switchable) voltage source. Accordingly, for the manufacture of a switchable liquid crystal cell, the method of the invention may further comprise the steps of
electrically contacting the conductive path of the lenticular lens to a first pole of a voltage source;
electrically contacting the conductive layer of the transparent plate to a second pole of the voltage source.

The resulting switchable liquid crystal cell may subsequently be used to manufacture a 2D/3D switchable autostereoscopic display device. To this end, the switchable liquid crystal cell is typically provided over an array of display pixel elements operably connected to a processor.

The sealing material, in particular a part thereof, may comprise second conductive particles that provide the formed sealing with a second conductive path. This second conductive path is preferably positioned in the sealing so as to electrically connect with the first conductive path. In this way, it contributes to the electrical accessibility of the conductive surface of the support.

The first and second conductive path may together electrically connect the conductive surface of the support with the conductive layer of the transparent plate (i.e. it then connects both planar electrodes). In such case, a portion of the conductive layer of the transparent plate that is in contact with the second conductive path is excised from the conductive layer to prevent a shortcut between the conductive layer of the transparent plate and the conductive surface of the support. In other words, there is a small ‘isle’ in the conductive layer of the transparent plate that is not in electrical contact within the rest of the conductive layer. This is illustrated in FIGS. 6 and 8 which will be further described below.

This architecture offers an advantageous way of connecting each electrode with one of the poles of a voltage source, since both connections are then at the same side of the liquid crystal cell.

The second conductive particles may have the same composition and/or properties as those described above for the first conductive particles. They may for example also be composed of a metal selected from the group of nickel, copper, palladium, silver, platinum and gold. They may for example also have a metallic outer surface that surrounds an inner material that is not conductive, such as a non-conductive polymer (e.g. an acrylate). Such metallic outer surface may be made of one or more metals selected from the group of nickel, copper, palladium, silver, platinum and gold. Preferably, all their metallic parts have the same electric potential.

The method of the invention yields a lenticular lens on a first planar electrode, wherein the first electrode is electrically accessible via the surface of the cured resin that makes up the lenticular lens. An important advantage of this method is that after the molding step, no post-processing is required to gain electrical access to the electrode. For example, it is not required to remove a portion of the cured resin to lay bare a portion of the planar electrode. This reduces waste in the form of resin and eventual solvent that may be used to remove the resin.

In addition, it is not necessary anymore to create a local area on the planar electrode with minimal resin thickness, which makes it obsolete to use an extremely protruding element on the mold (a ‘dam’) for the imprinting. Instead, an even resin thickness can be applied, other than the relief that constitutes the lenticular elements. Since it is most preferable to locate the conductive path outside the functional optical area, the area surrounding the functional optical area can be made with an even thickness. This is an advantage, since it simplifies the lens preparation process and introduces less artefacts and/or less local deformations during the lens preparation.

The present invention further relates to a lenticular device comprising
a support (2) comprising a conductive surface (3) capable of acting as a first electrode;
a layer of a transparent cured resin (4b) provided on the conductive surface (3) of the support (2), the transparent cured resin (4b) forming a lenticular lens having a shaped surface (5) comprising lenticular elements;
wherein
a part of the layer of transparent cured resin (4b) comprises first conductive particles (6), which provide the cured resin (4b) (and thus also the lenticular lens) with a conductive path (7) between the conductive surface (3) of the support and the shaped surface (5) of the lenticular lens.

For elements in such device, the same considerations apply as those elaborated hereabove for the corresponding elements in the method for preparing a lenticular lens, such as the dimensions of the first conductive particles, the nature and composition of the first conductive particles and the type of cured resin. A cross-sectional view of a lenticular device (1) according to the invention is provided as the end product of the method of the invention as illustrated in FIG. 2. A close-up of a portion thereof is displayed in FIG. 4. Herein, it can be seen that the first conductive particles (6) together form a conductive element (7).

The lenticular device is preferably used to produce a liquid crystal cell for an autostereoscopic display device. Accordingly, the invention further relates to a liquid crystal cell (10) comprising a cavity that is filled with a liquid crystal medium (16), the cavity being defined by at least
a lenticular device (1) as described hereabove;
a transparent plate (11) that is provided over the lenticular lens of the lenticular device (1) so that the transparent plate faces the shaped surface (5) of the lenticular lens, the transparent plate (11) comprising a conductive layer (13) capable of acting as a second electrode;
a sealing (12) that connects the lenticular device (1) and the transparent plate (11).

The invention further relates to an autostereoscopic display device comprising a liquid crystal cell (10) as described hereabove.

For elements in such liquid crystal cell or autostereoscopic display device, the same considerations apply as those elaborated hereabove for the corresponding elements in the method for preparing a liquid crystal cell, such as the transparent plate, the conductive layer thereon, the sealing, the dimensions of the second conductive particles and the nature and composition of the second conductive particles.

The transparent plate comprises a conductive layer capable of acting as a second electrode. Such conductive layer may be a conductive surface of the transparent plate.

In an embodiment, both the first and the second electrode are attached to a (switchable) voltage source. In this way, the liquid crystal medium that is sandwiched between them can be switched between two orientations of the liquid crystal.

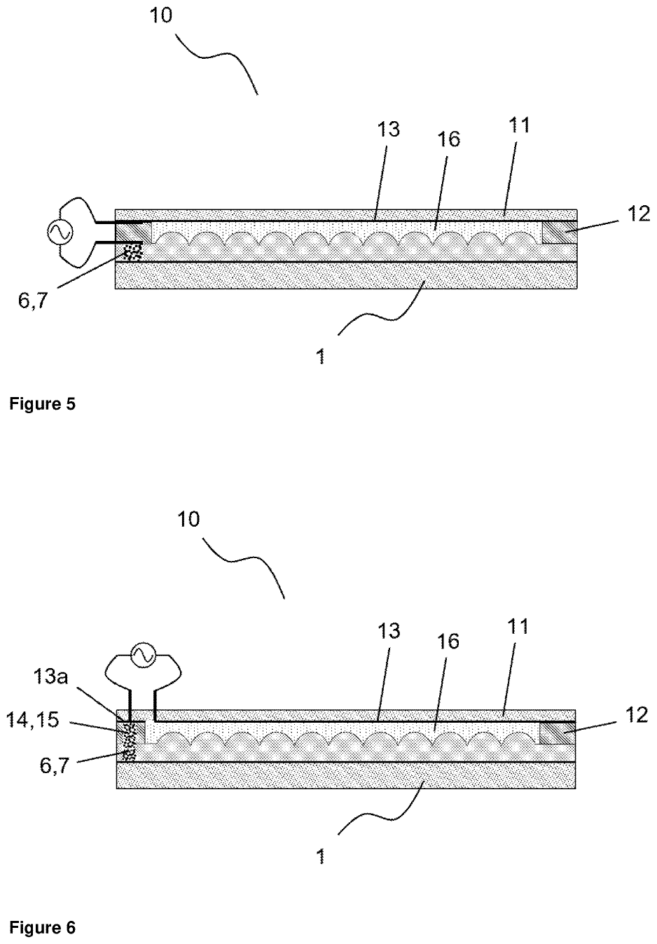

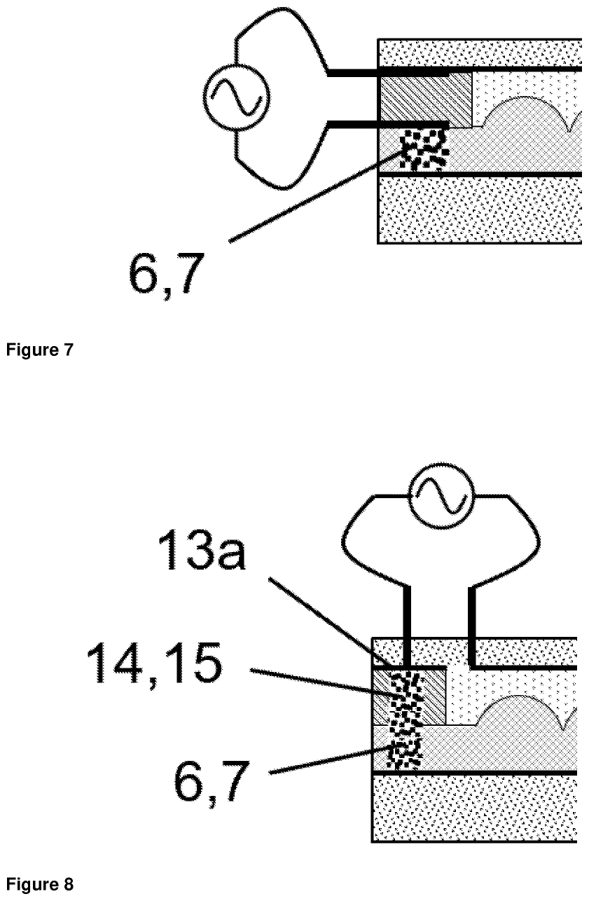

This embodiment is displayed in FIG. 5. A cross-sectional view of a first liquid crystal cell (10) according to the invention is presented here. A conductive path (7) is present in the lenticular lens material (i.e. in the resin). One pole of a voltage source is electrically connected to the conductive surface (3) of the support (2) (i.e. the first electrode) via the conductive path (7) at the lenticular surface. The other pole of the voltage source is connected to the conductive layer (13) of the transparent plate (11) (i.e. the second electrode). A magnification of the portion of the cell where the first conductive part (7) connects the conductive layer to the voltage source is displayed in FIG. 7.

The sealing (12) in the liquid crystal cell (10) may comprise second conductive particles (14) that provide the sealing (12) with a second conductive path (15). Preferably, this second conductive path (15) is at a position in the sealing (12) where it electrically connects with the first conductive path (7). In such case, the first electrode is electrically accessible via the sealing.

In a preferred embodiment, the first conductive path (7) and the second conductive path (15) together electrically connect the conductive surface (3) of the support (2) with a part (13a) of the conductive layer (13) of the transparent plate (11), which part (13a) is electrically disconnected from a remaining part of the conductive layer (13).

This embodiment is displayed in FIG. 6. A cross-sectional view of a second liquid crystal cell (10) according to the invention is presented here. A magnification of the portion of the cell where the first conductive part (7) and the second conductive part (15) together connect the conductive layer (13) to the voltage source is displayed in FIG. 8. Also displayed herein is the electrical isolation of a part (13a) of the conductive layer (13) from the remaining part of the conductive layer (13). The part (13a) connects to one pole of the voltage source, while the remaining part connects to the other pole of the voltage source.

1-15. (canceled)

16. A method for preparing a lenticular lens, the method comprising:
providing a layer of a curable resin on an electrically conductive surface of a transparent support;
providing a mold, the mold having a lenticular surface that corresponds to the lenticular lens in negative relief;
contacting the lenticular surface of the mold with the layer of a curable resin;
curing the curable resin to form a layer of a transparent cured resin; and
releasing the mold to yield the lenticular lens on the transparent support,
the lenticular lens having a shaped surface comprising lenticular elements,
a portion of the layer of the transparent cured resin including first electrically conductive particles,
the first electrically conductive particles providing the lenticular lens with an electrically conductive path between the electrically conductive surface of the transparent support and the shaped surface of the lenticular lens.

17. The method of claim 16, wherein the first electrically conductive particles have a largest dimension that is smaller than a thickness of the portion of the layer of the transparent cured resin.

18. The method of claim 16, wherein the first electrically conductive particles have a smallest dimension that is larger than a thickness of the portion of the layer of the transparent cured resin.

19. The method of claim 16, wherein the first electrically conductive particles have a metallic outer surface that surrounds an inner material that is not electrically conductive.

20. The method of claim 19, wherein the metallic outer surface comprises at least one of nickel, copper, palladium, silver, platinum, or gold.

21. The method of claim 16, wherein the curable resin comprises at least one of an epoxy resin or an acrylate resin.

22. The method of claim 16, further comprising preparing a liquid crystal cell by:
providing a transparent plate over the lenticular lens so that the transparent plate faces the shaped surface of the lenticular lens;
providing a sealing material between the lenticular lens and the transparent plate to form a cavity defined by the lenticular lens, the transparent plate and the sealing material;
allowing the sealing material to form a seal that adheres to the lenticular lens and adheres to the transparent plate; and
filling the cavity with a liquid crystal medium to thereby yield the liquid crystal cell.

23. The method of claim 22, wherein the transparent plate comprises an electrically conductive layer.

24. The method of claim 23, further comprising:
electrically connecting the electrically conductive path of the lenticular lens to a first pole of a voltage source; and
electrically connecting the electrically conductive layer of the transparent plate to a second pole of the voltage source.

25. The method of claim 22, wherein:
the electrically conductive path is a first electrically conductive path;
the sealing material comprises second electrically conductive particles that provide the seal with a second electrically conductive path; and
the second electrically conductive path electrically connects with the first electrically conductive path.

26. The method of claim 16, further comprising preparing a liquid crystal cell by:
applying a liquid crystal medium on the shaped surface of the lenticular lens;
applying a sealing material on a circumference of the shaped surface of the lenticular lens;
providing a transparent plate over the lenticular lens so that the transparent plate faces the shaped surface of the lenticular lens and contacts the sealing material and the liquid crystal medium;
allowing the sealing material to form a seal that adheres to the lenticular lens and adheres to the transparent plate to thereby yield the liquid crystal cell,
the liquid crystal medium occupying a cavity of the liquid crystal cell,
the cavity being defined by the lenticular lens, the transparent plate, and the sealing material.

27. The method of claim 26, wherein the transparent plate comprises an electrically conductive layer.

28. The method of claim 27, further comprising:
electrically connecting the electrically conductive path of the lenticular lens to a first pole of a voltage source; and
electrically connecting the electrically conductive layer of the transparent plate to a second pole of the voltage source.

29. The method of claim 26, wherein:
the electrically conductive path is a first electrically conductive path;
the sealing material comprises second electrically conductive particles that provide the seal with a second electrically conductive path; and
the second electrically conductive path electrically connects with the first electrically conductive path.

30. A lenticular device, comprising:
a support comprising an electrically conductive surface configured as a first electrode; and
a layer of a transparent cured resin disposed on the electrically conductive surface,
the transparent cured resin forming a lenticular lens having a shaped surface comprising lenticular elements,
a portion of the layer of the transparent cured resin including first electrically conductive particles,
the first electrically conductive particles providing the lenticular lens with an electrically conductive path between the electrically conductive surface of the support and the shaped surface of the lenticular lens.

31. A liquid crystal cell comprising a cavity filled with a liquid crystal medium, the cavity being defined by at least the lenticular device of claim 30,
a transparent plate disposed on the lenticular lens of the lenticular device such that the transparent plate faces the shaped surface of the lenticular lens, the transparent plate comprising an electrically conductive layer configured as a second electrode; and
a seal that connects the lenticular device and the transparent plate.

32. The liquid crystal cell of claim 31, wherein:
the electrically conductive path is a first electrically conductive path;
the seal comprises second electrically conductive particles;
the second electrically conductive particles provide the seal with a second electrically conductive path, and
the second electrically conductive path is located at a position in the seal where it the second electrically conductive path electrically connects with the first electrically conductive path.

33. The liquid crystal cell of claim 32, wherein:
the first electrically conductive path and the second electrically conductive path electrically connect the electrically conductive surface of the support with a portion of the electrically conductive layer of the transparent plate; and
the portion is electrically insulated from a remaining portion of the electrically conductive layer.
